(19) United States
(12) Patent Application Publication
(10) Pub. No.: US 2025/0132081 A1
(43) Pub. Date: Apr. 24, 2025

(54) EXTERNAL MAGNETIZATION SYSTEM USING MULTIPLE SOLENOID MODULES WITH HALBACH ARRAY AND OPERATION METHOD THEREFOR

(71) Applicant: ADVANCED INSTITUTE OF CONVERGENCE TECHNOLOGY, Suwon-si (KR)

(72) Inventors: Jun Kyeong KIM, Hwaseong-si (KR); Hak sun Kim, Seoul (KR); Se Hwan Park, Suwon-si (KR)

(21) Appl. No.: 19/001,651

(22) Filed: Dec. 26, 2024

Related U.S. Application Data
(63) Continuation of application No. PCT/KR2022/020267, filed on Dec. 13, 2022.

(30) Foreign Application Priority Data
Jun. 27, 2022 (KR) 10-2022-0078499

(51) Int. Cl. H01F 7/20; H01F 7/06

(52) U.S. Cl. CPC H01F 7/20; H01F 7/064

(57) ABSTRACT

Provided is an external magnetization system using multiple solenoid modules with a Halbach array. The external magnetization system comprises a support frame; a magnetization device including multiple solenoid modules arranged in a predetermined direction by a Halbach array along the support frame, and generating a plurality of magnetic lines in a predetermined direction for cross-sectional magnetization of a prestressed (PS) steel in a prestressed concrete (PC) member; a detection device measuring changes in a magnetic flux density associated with the plurality of magnetic lines; and A control device controlling the magnetization device in conjunction with the detection device.

### CROSS-REFERENCE TO RELATED APPLICATION

This application is a Continuation of Application No. PCT/KR2022/020267, filed on Dec. 13, 2022, which in turn claims the benefit of Korean Patent Application No. 10-2022-0078499, filed on Jun. 27, 2022. The entire disclosures of all these applications are hereby incorporated by reference.

This research was supported by the Korea Institute for Advancement of Technology, Ministry of Public Administration and Security (Project Number: 2310000040 and 00402840). The title of the research project is Development of Regional Customized Disaster Safety Problem-Solving Technology (Phase 2) (R&D), performed by Advanced Institute of Convergence Technology for 2024.04.01˜2026.12.31.

### BACKGROUND 1. Field of the Invention

The present specification relates to an external magnetization system using multiple solenoid modules with a Halbach array and an operating method thereof. More specifically, the present specification relates to an external magnetization system using the multiple solenoid modules having the Halbach array for magnetization of a prestressed (PS) steel (e.g., PS tendons and steel bars) included in a prestressed concrete bridge girder (hereinafter, “PSC girder”) to measure a tension stress of prestressed concrete (PC) members by utilizing an inverse magnetostrictive effect in which the permeability changes depending on the stress state of the magnetic body, and an operating method therefor.

### 2. Discussion of Related Art

A prestressed concrete bridge (hereinafter referred to as a “PSC bridge”) refers to a bridge with a structure that uses PS steel to introduce tension into prestressed concrete members (hereinafter referred to as “PC members”) to reduce deflection and cracking.

In particular, a safety rating of the PCS Type I bridge currently in service is continuously decreasing due to aging, and a risk of bridge collapse due to loss of tension in the aging PCS structure continues to increase.

Regular safety inspections are being conducted to maintain aging PCS bridges, but they are mainly conducted by visual inspection of external cracks, deflections, etc., rather than inspections focusing on the tension of prestressed concrete members. As a result, it is difficult to guarantee the safety of the bridge after cracks occur in the PCS bridge.

In particular, when a magnetic field is applied to an entire exterior of an existing PSC girder, the external magnetic field does not reach a PS tendon in a deep part due to the magnetic field shielding phenomenon caused by concrete and steel bars, there was a limitation that it was difficult to completely measure an interior of the PSC girder.

Accordingly, research is being conducted on non-destructive testing methods for measuring the tension of PSC bridges, such as a tension estimation technique using ultrasonic waves and elastic wave velocity, a tension estimation technique using vibration characteristics, and a tension estimation technique using magnetic fields.

In particular, in the case of PSC box bridges, it is difficult to install a magnetization device at both ends of the girder, and there is a problem that the magnetic flux density for magnetization the PS tendon in the deep part of the bridge is not sufficient.

For a previous proposal, refer to Korea Patent Publication No. 10-2015-0073349 on ‘Measurement method for tension stress and corrosion degree of prestressed steel using reverse magnetostriction phenomenon and induced magnetic field and electromagnet device therefor’.

### SUMMARY OF THE INVENTION

The first objective of the present specification is to provide an external magnetization system using multiple solenoid modules with a Halbach array comprising a support frame; a magnetization device including multiple solenoid modules arranged in a predetermined direction by a Halbach array along the support frame, and generating a plurality of magnetic lines in a predetermined direction for cross-sectional magnetization of a prestressed (PS) steel in a prestressed concrete (PC) member; a detection device measuring changes in a magnetic flux density associated with the plurality of magnetic lines; and a control device controlling the magnetization device in conjunction with the detection device, wherein the multiple solenoid modules include: a first solenoid module having N and S poles arranged in a predetermined direction; a second solenoid module arranged at one end associated with the N pole of the first solenoid module; and a third solenoid module arranged at the other end associated with the S pole of the first solenoid module.

When the N and S poles of the first solenoid module are arranged along a first direction, S and N poles of the second solenoid module are arranged along a second direction, and N and S poles of the third solenoid module are arranged along the second direction.

When the third objective of the present specification may be smoothly achieved by when the S and N poles of the first solenoid module are arranged along a first direction, S and N poles of the second solenoid module are arranged along a second direction, and N and S poles of the third solenoid module are arranged along the second direction.

The second objective of the present specification is to provide a method of operating an external magnetization system using multiple solenoid modules arranged in a predetermined direction by of a Halbach array on a single support frame, the method including: generating a plurality of magnetic lines for cross-sectional magnetization of PS steel within a PC member using the multiple solenoid modules; measuring changes in magnetic flux density associated with the PS steel using one or more magneto resistance sensors provided in the external magnetization system; and deriving a tension stress of the PS steel based on the changes in the magnetic flux density, wherein the multiple solenoid modules include: a first solenoid module having N and S poles arranged in a predetermined direction; a second solenoid module arranged at one end associated with the N pole of the first solenoid module; and a third solenoid module arranged at the other end associated with the S pole of the first solenoid module.

### BRIEF DESCRIPTION OF THE DRAWINGS

FIG. 1(a) and FIG. 1(b) are a drawing for explaining a principle of generating a synthetic magnetic field by focusing multiple externally generated magnetic fields.

FIG. 2 is a conceptual diagram for explaining formation of a magnetic field according to the arrangement of the Halbach array.

FIG. 3(a) and FIG. 3(b) are a drawing for explaining formation of a magnetic field according to arrangement for the multiple solenoid modules having the Halbach array according to the present embodiment.

FIG. 4 is a perspective view showing an external magnetization system using the multiple solenoid modules having the Halbach array according to the present embodiment.

FIG. 5 is a block diagram of an external magnetization system using the multiple solenoid modules having the Halbach array according to the present embodiment.

FIG. 6 is a drawing showing a structure of a solenoid module according to the present embodiment.

FIG. 7 is a flowchart showing an operation of an external magnetization system using the multiple solenoid modules having the Halbach array according to the present embodiment.

FIG. 8(a) and FIG. 8(b) show a simulation result screen for an external magnetization system using the multiple solenoid modules having the Halbach array according to the present embodiment.

FIG. 9 is a perspective view showing an external magnetization system using the multiple solenoid modules having the Halbach array according to another embodiment of the present invention.

FIG. 10(a) and FIG. 10(b) show a simulation result screen for an external magnetization system using the multiple solenoid modules having the Halbach array according to another embodiment of the present invention.

### DETAILED DESCRIPTION OF EXEMPLARY EMBODIMENTS

The above-described characteristics and the detailed description below are all exemplary matters to help the description and understanding of this specification. That is, this specification is not limited to these embodiments and may be embodied in other forms. The following embodiments are merely examples to completely disclose this specification and are explanations to convey this specification to those skilled in the art to which this specification belongs. Therefore, when there are multiple methods for implementing the components of this specification, it is necessary to make it clear that this specification may be implemented by any of these methods, either a specific one or an identical one.

When it is stated in this specification that a certain configuration includes certain elements, or when it is stated that a certain process includes certain steps, it means that other elements or other steps may be included. In other words, the terms used in this specification are only for describing specific embodiments, and are not intended to limit the concepts of this specification. Furthermore, examples described to help understanding the invention also include complementary embodiments thereof.

The terms used in this specification have the meanings generally understood by those skilled in the art to which this specification belongs. Commonly used terms should be interpreted in a consistent meaning according to the context of this specification. In addition, the terms used in this specification should not be interpreted in an overly idealistic or formal meaning unless their meanings are clearly defined. Hereinafter, embodiments of this specification are described with reference to the attached drawings.

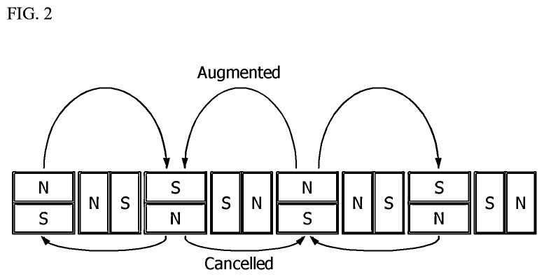

The “transverse direction” mentioned in this specification means the width direction (e.g., Y-axis in FIG. 2) of the PC member (2) that is horizontally orthogonal to the direction in which the PS steel (21) is arranged lengthwise and tension is introduced to the PC member (2) (e.g., Z-axis in FIG. 2).

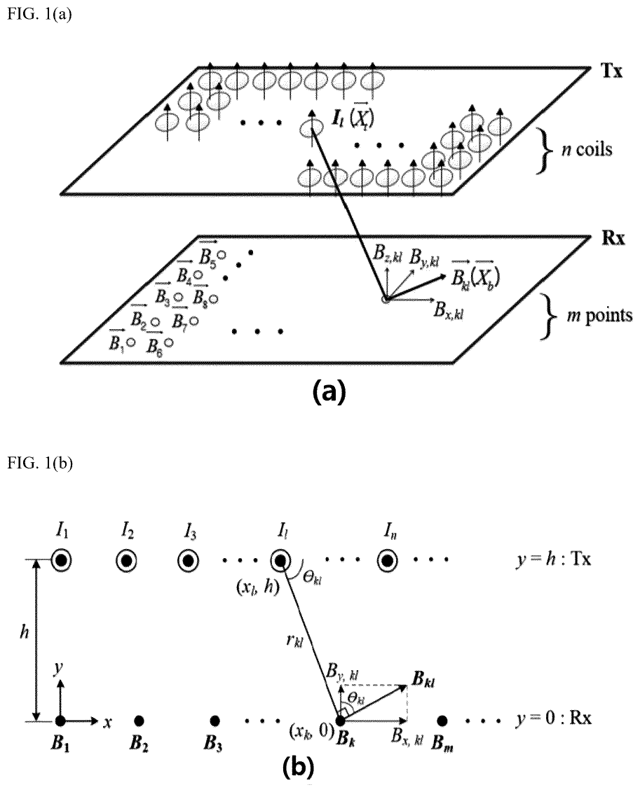

Meanwhile, the “longitudinal direction” mentioned in this specification means the height direction (e.g., X-axis in FIG. 2) of the external magnetization system (200) that is perpendicular to the width direction (e.g., Y-axis in FIG. 1) of the PC member (2).

FIG. 1 is a drawing for explaining a principle of generating a synthetic magnetic field by focusing multiple externally generated magnetic fields.

This specification relates to a synthesized magnetic field focusing (SMF) technology capable of appropriately controlling vectors of multiple magnetic fields using several direct current control transmission (Tx) coils.

In this specification, the arrangement of individual current sources and Tx coils and receiving (Rx) points, each represented by a point, may be modeled as shown in FIG. 1 (a).

Meanwhile, in order to obtain a magnetic field distribution concentrated on the Rx plane, the magnitude of each current source must be determined.

Meanwhile, referring to (b) of FIG. 1, a magnetic field density vector (\vec{Bkl}) generated from a current source (Iₗ) in free space may be defined as the following mathematical expression 1 for a one-dimensional model according to the Biot-Savart law.

$$\begin{matrix}\vec{{B}_{kl}} = {B}_{x , kl} \vec{{x}_{0}} + {B}_{y , kl} \vec{{y}_{0}} \\ = \frac{{μ}_{0} {I}_{l}}{2 π {r}_{kl}} ( sin {θ}_{kl} \vec{{x}_{0}} + cos {θ}_{kl} \vec{{y}_{0}} ) .\end{matrix} \qquad [ Mathematical Formual 1 ]$$

For reference, both k and 1 in the above mathematical expression 1 may be defined as integers greater than or equal to 1.

Meanwhile, rₖₗ in the above mathematical expression 1 may be defined as in the following mathematical expression 2.

$${r}_{kl} = \sqrt{{( {x}_{k} - {x}_{l} )}^{2} + {h}^{2}} , {θ}_{kl} = {tan}^{- 1} ( \frac{y}{{x}_{k} - {x}_{l}} ) \qquad [ Mathematical Formula 2 ]$$

Meanwhile, a total magnetic field density

$$( \vec{{B}_{k}} ) ,$$

which is the sum of all contributions made by all current sources, may be defined as in the following mathematical expression 3.

$$\vec{{B}_{k}} = {\sum }_{l = 1}^{n} \vec{{B}_{kl}} = \vec{{x}_{0}} {\sum }_{l = 1}^{n} {B}_{x , kl} + \vec{{y}_{0}} {\sum }_{l = 1}^{n} {B}_{y , kl} ≡ {B}_{x , k} \vec{{x}_{0}} + {B}_{y , k} \vec{{y}_{0}} . \qquad [ Mathematical Formula 3 ]$$

Referring to mathematical expressions 1 to 3 mentioned in FIG. 1, it will be understood that multiple magnetic fields may be focused at one or more desired locations by a user by adjusting current values applied to a particular system.

The principle of generating the synthetic magnetic field by focusing illustrated in FIG. 1 is described in more detail in the paper (Synthesized Magnetic Field Focusing Using a Current-Controlled Coil Array) published in IEEE MAGNETICS LETTERS (volume 7) in 2016.

FIG. 2 is a conceptual diagram for explaining formation of a magnetic field according to the arrangement of the Halbach array.

For reference, the Halbach array was first proposed by Klaus Halbach in 1979, and may generate a magnetic field distribution required for a specific system by combining a plurality of magnets.

That is, when the plurality of magnets (i.e., permanent magnets) are arranged according to the Halbach array, the strength and direction of the magnetic field for the entire system may be changed.

For example, when the plurality of magnets (e.g., solenoid modules) are arranged according to the Halbach array as shown in FIG. 2, the magnetic field formed in one direction (e.g., downward) may be canceled, and the magnetic field formed in the other direction (e.g., upward) may be concentrated by a certain amount.

In addition, the number of magnets (e.g., solenoid modules) shown in FIG. 2 is only an example, and it will be understood that this specification is not limited thereto.

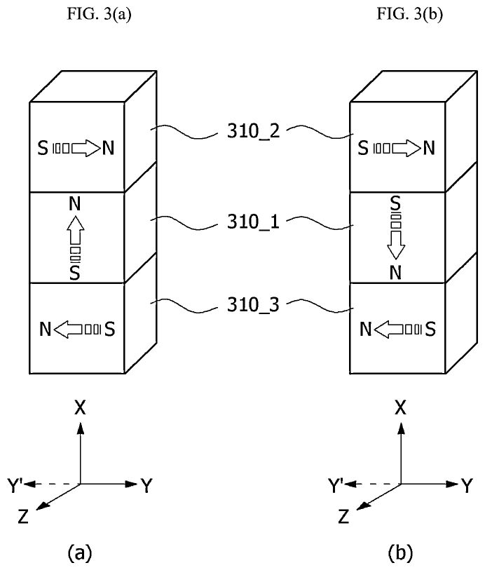

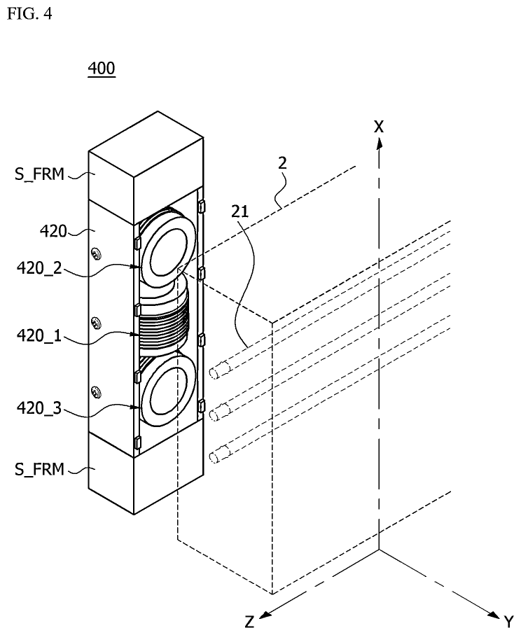

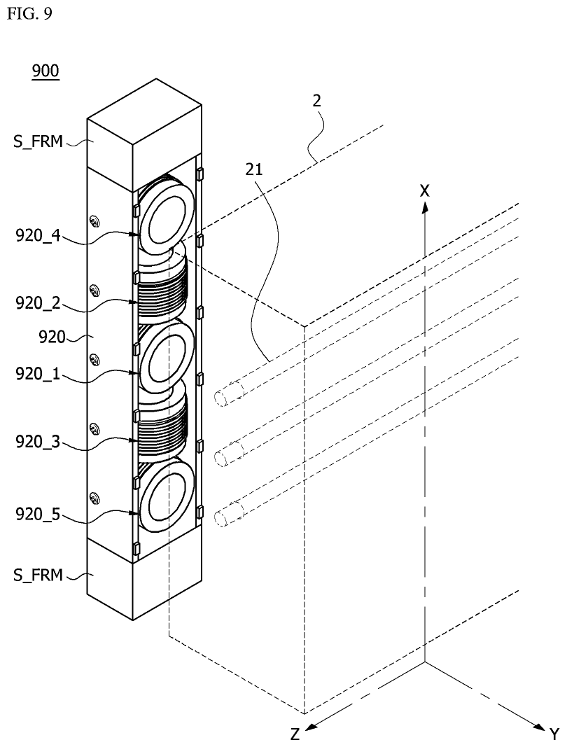

That is, the magnetization device may be configured to include three magnets (e.g., solenoid modules) as shown in FIGS. 3 and 4 described below, or the magnetization device may be configured to include three magnets (e.g., solenoid modules) as shown in FIG. 9.

FIG. 3 is a drawing for explaining the formation of the magnetic field according to the arrangement for the multiple solenoid modules having the Halbach array according to the present embodiment.

It may be understood that the plurality of magnets (i.e., permanent magnets) illustrated in FIG. 3 correspond to the multiple solenoid modules according to the present embodiment. Although the number of magnets (i.e., permanent magnets) illustrated in FIG. 3 is three, it will be understood that the present specification is not limited thereto, and may include five or more magnets (i.e., permanent magnets).

Referring to FIGS. 1 to 3, the multiple solenoid modules of FIG. 3 may be understood as three solenoid modules (310_1 to 310_3) forming one group.

Referring to FIG. 3 (a), the N and S poles of the first solenoid module (310_1) of FIG. 3 (a) may be arranged along the first direction (the X direction of FIG. 3, the longitudinal direction).

The second solenoid module (310_2) of FIG. 3 (a) may be arranged at one end associated with the N pole of the first solenoid module (310_1). In this case, the second solenoid module (310_2) of FIG. 3 (a) may have the S and N poles arranged along the second direction (the Y direction of FIG. 3, the transverse direction).

The third solenoid module (310_3) of FIG. 3 (a) may be arranged at one end associated with the S pole of the first solenoid module (310_1). The third solenoid module (310_3) of FIG. 3 (a) may have the N and S poles arranged along the second direction (the Y direction of FIG. 3, the transverse direction).

In this case, it will be understood that the magnetic field is augmented in the second direction (Y direction, transverse direction of FIG. 3) by the multiple solenoid modules (310_1 to 310_3) having the Halbach array illustrated in (a) of FIG. 3.

Referring to (b) of FIG. 3, the S and N poles of the first solenoid module (310_1) of FIG. 3 (b) may be arranged along the first direction (X direction, longitudinal direction of FIG. 3).

The second solenoid module (310_2) of FIG. 3 (b) may be arranged at one end associated with the S pole of the first solenoid module (310_1). In this case, the S and N poles of the second solenoid module (310_2) of FIG. 3 (b) may be arranged along the second direction (Y direction, transverse direction of FIG. 3).

The third solenoid module (310_3) of FIG. 3 (b) may be arranged at one end associated with the N pole of the first solenoid module (310_1). The third solenoid module (310_3) of FIG. 3 (b) may have N and S poles arranged along the second direction (Y direction of FIG. 3, transverse direction).

It will be understood that the magnetic field is augmented in the opposite direction (Y′ direction in FIG. 3) to the second direction (Y direction in FIG. 3) by the multiple solenoid modules (310_1 to 310_3) having the Halbach array illustrated in (b) of FIG. 3.

It will be understood that by applying the multiple solenoid modules having the Halbach array of FIG. 3, a cross-sectional magnetization function may be implemented in which the magnetic field is intensively formed in the second direction (Y direction of FIG. 3) or in the opposite direction to the second direction (Y′ direction of FIG. 3).

FIG. 4 is a perspective view showing an external magnetization system using the multiple solenoid modules having the Halbach array according to the present embodiment.

Referring to FIGS. 1 to 4, an external magnetization system (400) using the multiple solenoid modules having the Halbach array according to an embodiment of the present invention may include a support frame (S_FRM), a magnetization device (410), a detection device (420) and a control device (not shown).

The support frame (S_FRM) of FIG. 4 may be arranged parallel to the longitudinal direction (X-axis). multiple solenoid modules (410_1 to 410_3) having a predetermined number and direction according to the Halbach array may be placed on the support frame (S_FRM).

The magnetization device of FIG. 4 may include the multiple solenoid modules (410_1 to 410_3), and the multiple solenoid modules (410_1 to 410_3) may be set to have the same number and direction of N and S poles as (a) of FIG. 3 described above.

Meanwhile, as described above, the number (three) and installation direction of the multiple solenoid modules in FIG. 4 are only examples, and it will be understood that this specification is not limited thereto.

In this case, the multiple solenoid modules (410_1 to 410_3) of FIG. 4 may generate a plurality of magnetic lines that are augmented in the second direction (Y direction, transverse direction of FIG. 3) determined in advance under control by the control device (not shown). In this case, the plurality of magnetic lines generated intensively along the second direction (Y direction, transverse direction in FIG. 3) predetermined by the plurality of solenoid modules (410_1 to 410_3) may magnetize the PS steel (21) located deep within the PC member (2).

The detection device (420) of FIG. 4 may be placed at a predetermined position on the support frame (S_FRM).

For example, the detection device (420) of FIG. 4 may be implemented based on one or more Hall sensors or one or more Magneto Resistance sensors for measuring the changes in the magnetic flux density (i.e., the strength of the magnetic field) of the plurality of magnetic lines associated with the degree of magnetization of the PS steel (21).

Information on the changes in the magnetic flux density measured by the detection device (420) of FIG. 4 may be transmitted to the control device (not shown). In this case, the control device (not shown) may be implemented to independently control the multiple solenoid modules (410_1 to 410_3) in conjunction with the detection device (420) implemented with one or more Hall sensors or one or more magnetoresistive effect (MR) sensors.

In this specification, the multiple solenoid modules (410_1 to 410_3) may be implemented to amplify or attenuate a magnetic field at a specific location by individually adjusting a current value applied from the control module (not shown) based on the principle of generating the synthetic magnetic field by focusing for the multiple magnetic fields of FIG. 1 described above.

Additionally, the multiple solenoid modules (410_1 to 410_3) may be implemented to magnetize a target at a specific location based on the Halbach array principle of FIG. 3 described above.

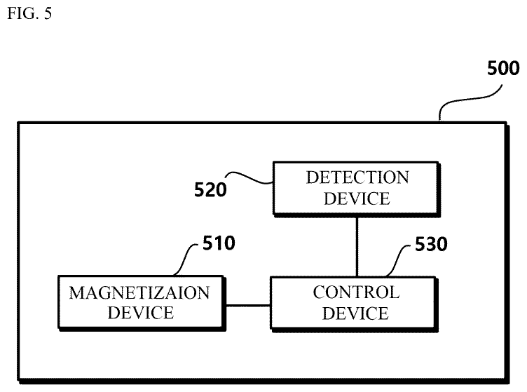

FIG. 5 is a block diagram of an external magnetization system using the multiple solenoid modules having the Halbach array according to an embodiment of the present invention.

Referring to FIGS. 1 to 5, an external magnetization system (500) utilizing the multiple solenoid modules having the Halbach array of FIG. 5 may include a magnetization device (510), a detection device (520) and a control device (530).

The magnetization device (510) of FIG. 5 may be understood as having a configuration corresponding to the magnetization device (410) of the preceding FIG. 4.

For example, the magnetization device (510) of FIG. 5 may generate the plurality of magnetic lines (i.e., generate the magnetic field) from the multiple solenoid modules (e.g., 410_1 to 410_3 of FIG. 4) under control by the control device (530).

For example, to amplify or attenuate a magnetic field corresponding to a specific location, multiple input currents individually set for each of the multiple solenoid modules (e.g., 410_1 to 410_3 in FIG. 4) may be applied from the control device (530).

The detection device (520) of FIG. 5 may be implemented based on one or more Hall sensors or one or more Magneto Resistance (hereinafter referred to as ‘MR’) sensors provided at predetermined locations.

Here, one or more Hall sensors or one or more magnetoresistive effect (MR) sensors may measure the changes in magnetic flux density for a plurality of magnetic lines associated with the PS steel (e.g., 21 in FIG. 4).

The control device (530) of FIG. 5 may control the overall operation of the magnetization device (510) in conjunction with the detection device (520).

That is, the control device (530) may be implemented to calculate the stress change of the magnetic body (i.e., steel) due to the reverse magnetostriction effect based on the information measured from the detection device (520).

Meanwhile, the control device (530) may include at least one processor, a computer-readable storage medium, and a communication bus. Here, the processor may cause the control device (530) to operate according to the exemplary embodiment mentioned above.

Here, the processor may be implemented to cause the control device (530) to operate according to the exemplary embodiment mentioned above.

For example, the processor may execute one or more programs stored on a computer-readable storage medium. The one or more programs may include one or more computer-executable instructions, which, when executed by the processor, may be configured to cause the control device (530) to perform operations according to the exemplary embodiment.

Meanwhile, the computer-readable storage medium may be configured to store computer-executable instructions or program code, program data, and/or other suitable forms of information. A program stored in the computer-readable storage medium includes a set of instructions executable by a processor.

In one embodiment, the computer-readable storage medium may be memory (volatile memory such as random access memory, nonvolatile memory, or a suitable combination thereof), one or more magnetic disk storage devices, optical disk storage devices, flash memory devices, any other form of storage medium that may be accessed by the control device (530) and may store desired information, or a suitable combination thereof.

Meanwhile, the communication bus may interconnect various other components of the control device (530), including a processor and a computer-readable storage medium.

The control device (530) may also include one or more input/output interfaces providing interfaces for one or more input/output devices and one or more network communication interfaces.

The input/output interface and the network communication interface may be connected to a communication bus. The input/output device may be connected to other components of the control device (530) via the input/output interface.

Exemplary input/output devices may include input devices such as pointing devices (such as a mouse or trackpad), keyboards, touch input devices (such as a touchpad or touchscreen), voice or sound input devices, various types of sensor devices, and/or photographing devices, and/or output devices such as display devices, printers, speakers, and/or network cards.

An exemplary input/output device may be included within the control device (530) as a component constituting the control device (530), or may be connected to the processor as a separate device distinct from the control device (530).

Although not shown in FIG. 5, the control device (530) according to the present embodiment may further include a power supply module (not shown) for input currents applied to the multiple solenoid modules (e.g., 410_1 to 410_3 of FIG. 4).

Here, the power supply module (not shown) may be implemented to include one or more power amplifiers to individually generate input currents for each of the multiple solenoid modules (e.g., 410_1 to 410_3 of FIG. 4).

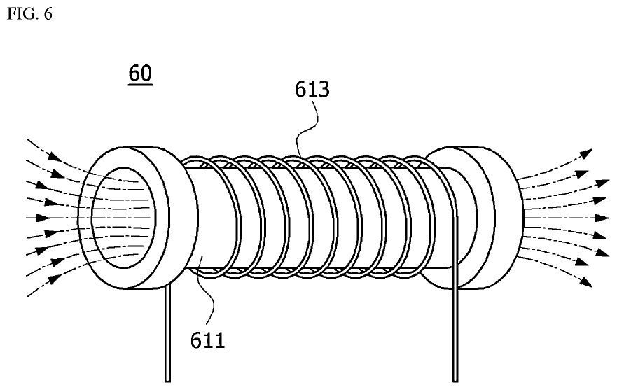

FIG. 6 is a drawing showing a structure of a solenoid module according to the present embodiment.

Referring to FIGS. 1 to 6, it will be understood that the structure of the solenoid module (60) illustrated in FIG. 6 is applicable to the multiple solenoid modules (410_1 to 410_3) of FIG. 4 described above.

Referring to FIG. 6, the solenoid module (60) may be implemented using a bobbin (611) and a conductor (613).

For example, a predetermined material (e.g., nickel alloy) may be used for the bobbin (611). The conductor (613) may be a copper wire having a predetermined thickness (e.g., 2ø).

In addition, the conductor (613) may be wound in a predetermined direction with a predetermined number of turns (N, e.g., 40 turns) for each layer of a predetermined number of layers (e.g., 6 layers) on the bobbin (611).

That is, the conductor (613) may be wound on the bobbin (611) as many times as a total number of turns (N′, for example, 240 turns).

For example, it will be understood that the magnitude of the magnetic field generated by the solenoid module (60) may be determined according to a magnitude and direction of a current applied from the control device (e.g., 530 of FIG. 5).

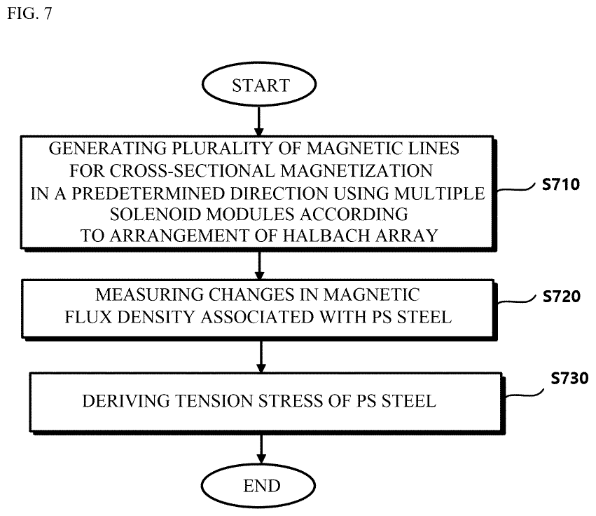

FIG. 7 is a flowchart showing an operation of an external magnetization system using the multiple solenoid modules having the Halbach array according to the present embodiment.

Referring to FIGS. 1 to 7, at step S710, the external magnetization system (e.g., 500 of FIG. 5) according to the present embodiment may generate a plurality of magnetic lines (i.e., magnetic fields) in a predetermined direction (e.g., Y direction, transverse direction of FIG. 4) by using the multiple solenoid modules (e.g., 410_1 to 410_3 of FIG. 4) according to the arrangement of the Halbach array.

At step S720, the external magnetization system (e.g., 500 of FIG. 5) according to the present embodiment may detect the changes in magnetic flux density for the plurality of magnetic lines (i.e., magnetic fields) generated based on a detection operation of the detection device (e.g., 520 of FIG. 5) including one or more magnetoresistance effect (MR) sensors provided at predetermined locations.

Here, detection information related to the changes in magnetic flux density for the plurality of magnetic lines may be transmitted to the control device (e.g., 530 of FIG. 5).

At step S730, the external magnetization system (e.g., 500 in FIG. 5) according to the present embodiment may identify the stress change for the PS steel (e.g., 21 in FIG. 5) based on the detection information associated with the changes in the magnetic flux density, and may also derive the tension stress of the PS steel (e.g., 21 in FIG. 5).

As mentioned above in relation to the background technology, according to the Villari Effect or the reverse magnetostriction effect, which is widely known in the field of physics of magnetic materials, the stress change of the steel, which is a magnetic body, is accompanied by a change in the permeability.

Here, the mathematical relationship between the stress change of the steel and the change in the permeability is already known through various publicly known technologies including Korean Patent No. 10-0573735.

According to this embodiment, since the magnetic field may reach the depth of an aged PSC bridge that may not be confirmed by existing precision safety diagnosis techniques, the tension and internal condition of the bridge may be diagnosed more precisely.

Specifically, according to the present embodiment, by applying the solenoid structure having the Halbach array, the strength of the magnetic field increases by about twice compared to the conventional method of winding a coil on a plate-shaped ferromagnetic body, making it easier for the magnetic field to reach the PS tendon, thereby enabling more accurate estimation of the residual tension.

In addition, according to the present embodiment, there is an advantage in that it may be applied relatively freely from restrictions on the shape and inspection area of the PSC girder due to the structure that is advantageous for miniaturization compared to existing structures.

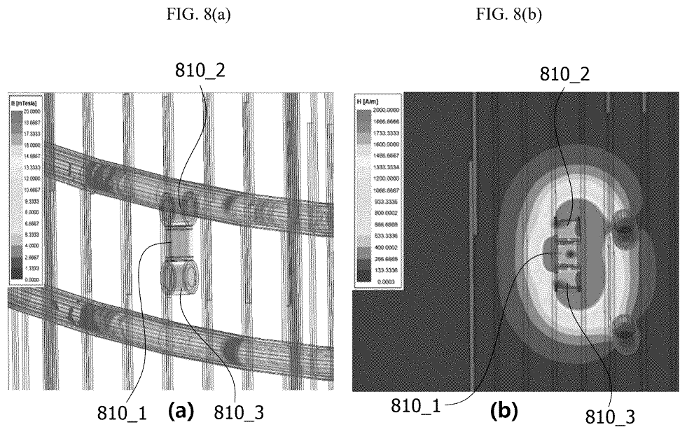

FIG. 8 shows a simulation result screen for an external magnetization system using the multiple solenoid modules having the Halbach array according to the present embodiment.

Referring to FIGS. 1 to 8, the multiple solenoid modules (810_1 to 810_3) according to the Halbach array of FIG. 8 (a) may be understood as having a configuration corresponding to the multiple solenoid modules (410_1 to 410_3) of FIG. 4 described above.

Meanwhile, the magnetization device (510) of FIG. 5 may be implemented based on the multiple solenoid modules (410_1 to 410_3) according to the arrangement of the Halbach array as described above.

Meanwhile, FIG. 8 (b) corresponds to a simulation result screen showing the magnetization degree on the X-Y plane for the operation of the external magnetization system according to the present embodiment, and may be understood as a screen in which a finite element analysis is performed by placing a type I girder on one side of the array solenoid modules (810_1 to 810_3) according to the arrangement of the Halbach array.

That is, it is confirmed that the unidirectional magnetization performance of the external magnetization device according to the present embodiment is excellent, and the magnetic field generated by the plurality of solenoid modules (810_1 to 810_3) provided on one side passes through a portion of the sheath tube and reaches the tendon.

FIG. 9 is a perspective view showing an external magnetization system using the multiple solenoid modules having the Halbach array according to another embodiment of the present invention.

Referring to FIGS. 1 to 9, multiple solenoid modules (910_1 to 910_5) of FIG. 9 may generate a plurality of magnetic lines that are augmented in a predetermined direction (e.g., the Y direction and the transverse direction of FIG. 9) by being arranged in a direction according to the arrangement of the Halbach array mentioned in FIG. 2 above.

It will be understood that multiple solenoid modules (910_1 to 910_5) according to the arrangement of the Halbach array of FIG. 9 is only an example, and the multiple solenoid modules (910_1 to 910_5) may be changed depending on a target position for magnetization.

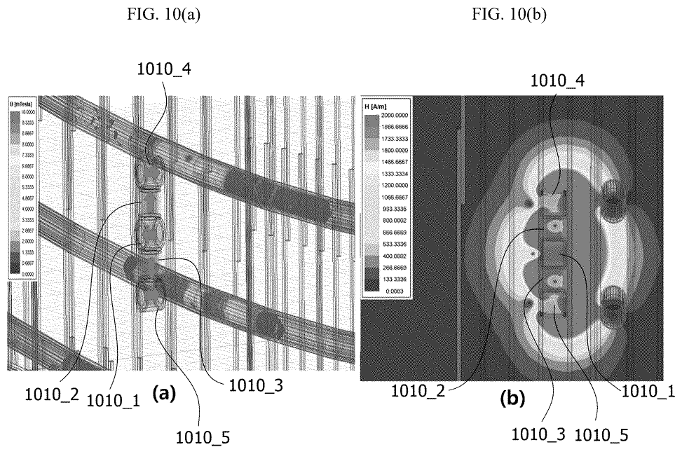

FIG. 10 shows a simulation result screen for an external magnetization system using the multiple solenoid modules having the Halbach array according to another embodiment of the present invention.

Referring to FIGS. 1 to 10, it will be understood that input currents having different magnitudes may be individually applied to multiple solenoid modules (1010_1 to 1010_5) according to the arrangement of the Halbach array of FIG. 10 (a).

Meanwhile, FIG. 10 (b) corresponds to a simulation result screen showing the degree of magnetization on the X-Y plane for the operation of the external magnetization system according to another embodiment of the present invention, and may be understood as a screen in which a finite element analysis was performed by placing a type I girder on one side of the multiple solenoid modules (1010_5 to 1010_5) according to the arrangement of the Halbach array.

In this case, it was confirmed that the magnetic flux density generated by the multiple solenoid modules (1010_5 to 1010_5) according to the other embodiment was approximately 10,000 times greater than the magnetic flux density generated in the existing plate-shaped frame.

That is, it is confirmed that the unidirectional magnetization performance of the external magnetization device according to the present other embodiment is excellent, and the magnetic field generated by the multiple solenoid modules (1010_1 to 1010_5) provided on one side passes through a portion of the sheath tube and reaches the tendon.

Although the detailed description of this specification has described specific embodiments, various modifications are possible without departing from the scope of this specification. Therefore, the scope of this specification should not be limited to the above-described embodiments, but should be determined by the equivalents of the claims of this invention as well as the claims described below.

What is claimed is:

1. An external magnetization system using multiple solenoid modules with a Halbach array, the external magnetization system comprising:
a support frame;
a magnetization device including multiple solenoid modules arranged in a predetermined direction by a Halbach array along the support frame, and generating a plurality of magnetic lines in a predetermined direction for cross-sectional magnetization of a prestressed (PS) steel in a prestressed concrete (PC) member;
a detection device measuring changes in a magnetic flux density associated with the plurality of magnetic lines; and
A control device controlling the magnetization device in conjunction with the detection device,
wherein the multiple solenoid modules include:
a first solenoid module having N and S poles arranged in a predetermined direction;
a second solenoid module arranged at one end associated with the N pole of the first solenoid module; and
a third solenoid module arranged at the other end associated with the S pole of the first solenoid module.

2. The method of claim 1, wherein when the N and S poles of the first solenoid module are arranged along a first direction, S and N poles of the second solenoid module are arranged along a second direction, and wherein N and S poles of the third solenoid module are arranged along the second direction.

3. The method of claim 1, wherein when the S and N poles of the first solenoid module are arranged along a first direction, S and N poles of the second solenoid module are arranged along a second direction, and
wherein N and S poles of the third solenoid module are arranged along the second direction.

4. The method of claim 1, wherein the detection device includes one or more magneto resistance sensors.

5. A method of operating an external magnetization system using multiple solenoid modules arranged in a predetermined direction by a Halbach array on a single support frame, the method including:
generating a plurality of magnetic lines for cross-sectional magnetization of a PS steel within a PC member using the multiple solenoid modules;
measuring changes in a magnetic flux density associated with the PS steel using one or more magneto resistance sensors provided in the external magnetization system; and
deriving a tension stress of the PS steel based on the changes in the magnetic flux density,
wherein the multiple solenoid modules include:
a first solenoid module having N and S poles arranged in a predetermined direction;
a second solenoid module arranged at one end associated with the N pole of the first solenoid module; and
a third solenoid module arranged at the other end associated with the S pole of the first solenoid module.
